(19) United States
(12) Patent Application Publication
(10) Pub. No.: US 2007/0296994 A1
(43) Pub. Date: Dec. 27, 2007

(54) Reprographic submission and tracking system and method

(76) Inventor: Ashvin Radiya, San Jose, CA (US)

Correspondence Address: Silicon Valley Patent Group LLP;Attn: Bryan H. Wyman, 18805 Cox Avenue, Suite 220, Saratoga, CA, 95070, US

(21) Appl. No.: 11/471,809

(22) Filed: Jun. 21, 2006

(51) Int. Cl. G06F 3/12

(52) U.S. Cl. 358/1.13

(57) ABSTRACT

A reprographic submission and tracking system, apparatus, and method are disclosed. In one embodiment a reprographic client module includes providing a summary of at least one previously completed request associated with a reprographic submission, generating a reproduction request that can be customized based on a set of configurable parameters and providing a tracking information of a reproduction request through a communication with a reprographic provider module through a network. A parameter of the at least one previously completed request associated with the reprographic submission may be applied to the reproduction request. The reproduction request may be generated by merging a set of documents to a unitary project file comprising each of the set of documents. The reprographic client module may permit a submission of multiple distinct project files simultaneously to the reprographic provider module through the network. A set of selectable parameters of the reprographic client module may be periodically refreshed based on a data state change at the reprographic provider module through the network.

### FIELD OF TECHNOLOGY

This disclosure relates generally to the technical fields of computer technology and, in one example embodiment, to a system, an apparatus, and/or a method of reprographic submission and tracking.

### BACKGROUND

A reprographic provider (e.g., FedEx® Kinkos®, Alphagraphics®, a local print shop, etc.) may offer a service of reproducing a graphical and/or a textual information (e.g., a document, a poster, a book, a sign, a plate, etc.) through a mechanical technique and/or an electrical technique. For example, the reprographic provider may provide a photocopying service (e.g., a process which makes paper duplications of documents).

A repeat client of the reprographic provider may frequently (e.g., weekly, monthly, etc.) provide a reproduction request to the reprographic provider. A print driver (e.g., an operating system extension activated when printing a document) offered by the reprographic provider may enable the repeat client (e.g., a training company, a law firm, etc.) to submit the reproduction request through a network (e.g., an Internet). The reproduction request may have similar characteristics as a previously completed request (e.g., similar quantity, similar color, similar paper type, similar parameters, similar binding, etc.).

If the repeat client does not manually remember (e.g., recollect, bear in mind, rouse, bethink, etc.) the similar characteristics of the previously completed request, the repeat client may need to look through physical files, manually inspect paper records, and/or call the reprographic provider through a telephone before submitting the reproduction request. If the repeat client is in a rush, the repeat client may take a guess of the similar characteristics that is wrong, and may be delivered output from the reprographic provider that is undesirably different than the previously completed request (e.g., nonconforming, visually different, physically different, etc.).

In addition, the repeat client may need to spend time in calling the reprographic provider to check a status on the reproduction request provided through the print driver. Sometimes, the repeat client may be placed on long hold queues when calling the reprographic provider, and may need to invest significant time, money, and/or resources over the telephone to submit and track the reproduction request (e.g., possibly having similar/same characteristics as the previously completed request).

Different documents (e.g., a project) that the repeat client may wish to have simultaneously reproduced (e.g., by the reprographic provider) may need to be individually submitted and/or compiled by the repeat client. For example, the repeat client may need to open each of the different documents individually and/or submit each document singularly through the print driver. In addition, the repeat client may need to individually open each of the different documents to retrieve financial spend information of the reproduction request and/or previously completed requests. All these challenges can make a relationship between the repeat client and the reprographic provider time consuming, burdensome, quirky, expensive, and/or inefficient.

### SUMMARY

A reprographic submission and tracking system, apparatus, and method are disclosed. In one aspect a method of a reprographic client module includes providing a summary of at least one previously completed request associated with a reprographic submission, generating a reproduction request customized based on a set of configurable parameters and providing a tracking information of the reproduction request through a communication with a reprographic provider module through a network. A parameter of the at least one previously completed request associated with the reprographic submission may be applied to the reproduction request. The parameter may be a paper size, a delivery time, a binding type, and/or a paper color. A set of selectable parameters of the reprographic client module may be periodically refreshed based on a data state change at the reprographic provider module through the network. The data state change may be a new offering, a stock status of an item associated with the parameter, an equipment availability, a scheduling capacity, and/or a feature availability.

The reproduction request may be communicated in a structured data decryptable by the reprographic provider module. The structured data may include a meta data having a tracking information, customer information, acceptance information, and/or confirmation information that can be responded to by the reprographic provider module. A scrolling announcement bar on the reprographic client module having a set of advertisements periodically refreshed by the reprographic provider module may be displayed.

There may be automatic refreshment of the reprographic client module to an updated process flow when a command of the reprographic provider module provides revised interactivity data to the reprographic client module. An offline user of the reprographic client module may be permitted to automatically port parameters provided through an older process flow when the updated process flow is integrated upon the offline user arriving online and at least some historical data arranged in the older process flow, the updated process flow, and any other intermediate process flow may be simultaneously compared through a pivot field of the at least some historical data. Also, future versions of the summary may be enabled to simultaneously display the at least one previously completed request and the reproduction request through a retention of the at least one previously completed request and the reproduction request on a storage space associated with the reprographic client module.

A corporate identifier of a reprographic provider associated with the reprographic client module may be provided through a graphical marker on an interface of the reprographic client module, and the reprographic provider may process the reproduction request through the network. The reproduction request may be generated in a set of profile data associated with a printing category associated with the reproduction request. The printing category may be a calendar category, a photo category, a business card category, a report category, an offset printing category, and/or a paper printing category.

The reproduction request may be generated by merging a set of documents to a unitary project file comprising each of the set of documents. The reprographic client module may permit a submission of multiple distinct project files simultaneously to the reprographic provider module through the network in the reproduction request. Documents may be accessed on a document store that may be maintained on the reprographic provider module and may be reapplied through a drag and drop methodology.

A customizable job tracking information related to the reproduction request, including a job accepted indicator, a job completed indicator and/or a job delivered indicator may be provided. A notification of a change in the customizable job tracking information may be communicated through an automated voice message means, an email means, and/or a flag update to the reprographic client module through the network. The reprographic client module and the reprographic provider module may communicate with each other through a messaging system tied to a particular project and/or a particular document of the reproduction request. The reprographic client module may permit a draft status of the particular project and/or the particular document prior to the communication with the reprographic provider module. The reprographic client module may be accessed through a standalone application, a print driver, and/or a web based mark-up language application.

In another aspect a method of a reprographic provider module includes generating an update data associated with a set of conditions and constraints of a print shop when a parameter changes from a threshold value and propagating the update data to a plurality of reprographic client modules through a handshake notification system that automatically communicates the update data through a network when the update data is refreshed. A set of scrolling advertisement data may be provided to the plurality of reprographic client modules to create incremental revenue opportunities to the reprographic provider module.

In yet another aspect a system includes a print shop having a reprographic provider module to generate a messaging data and a tracking data responsive to a reproduction request of a reprographic client module through a network, and to automatically propagate capacity and availability of printing equipment constraint data to the reprographic client module and/or other reprographic client modules through the network and a set of repeat clients each having a reprographic client modules to automatically apply a parameter of a previously completed request associated with a reprographic submission to the reproduction request. The reprographic client modules may be a printer driver and/or a standalone application distributed by a technology company.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a network diagram of a reprographic client module and a reprographic provider module communicating a reproduction request and/or a tracking information through a network according to one embodiment.

FIG. 2 is an exploded view of the reprographic client module of FIG. 1, according to one embodiment.

FIG. 3 is an exploded view of the reprographic provider module of FIG. 1, according to one embodiment.

FIG. 4A-4D are user interface views of the reprographic client module of FIG. 1, according to one embodiment.

FIG. 5A-5B are user interface views of the reprographic provider module of FIG. 1, according to one embodiment.

FIG. 6 is a diagrammatic representation of a data processing system capable of processing a set of instructions to perform any one or more of the methodologies herein, according to one embodiment.

FIG. 7 is a graphical illustration of a unitary project file having a set of documents, according to one embodiment.

FIG. 8 is a graphical illustration of an interaction between the document management module of FIG. 2 and a document store database, according to one embodiment.

FIG. 9 is a flow chart illustrating a method of the reprographic client module of FIG. 1 to generate the reproduction request, submit the reproduction request to the reprographic provider module and track the reproduction request through the network, according to one embodiment.

FIG. 10 is a process diagram that describes further the operations of FIG. 9, according to one embodiment.

FIG. 11 is a process diagram that describes further the operation of FIG. 10, according to one embodiment.

FIG. 12 is a flow chart illustrating a method of the reprographic provider module of FIG. 1 to automatically update the reprographic client module based on a set of conditions, according to one embodiment.

Other features of the present embodiments will be apparent from the accompanying drawings and from the detailed description that follows.

### DETAILED DESCRIPTION

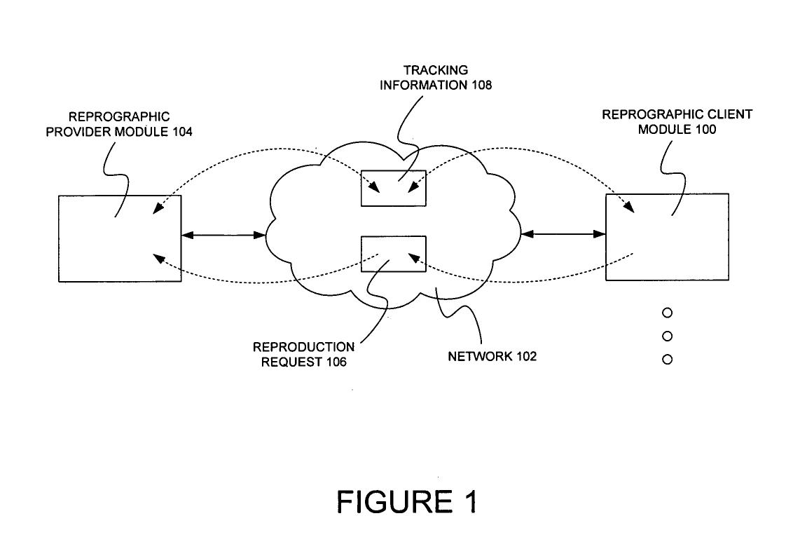

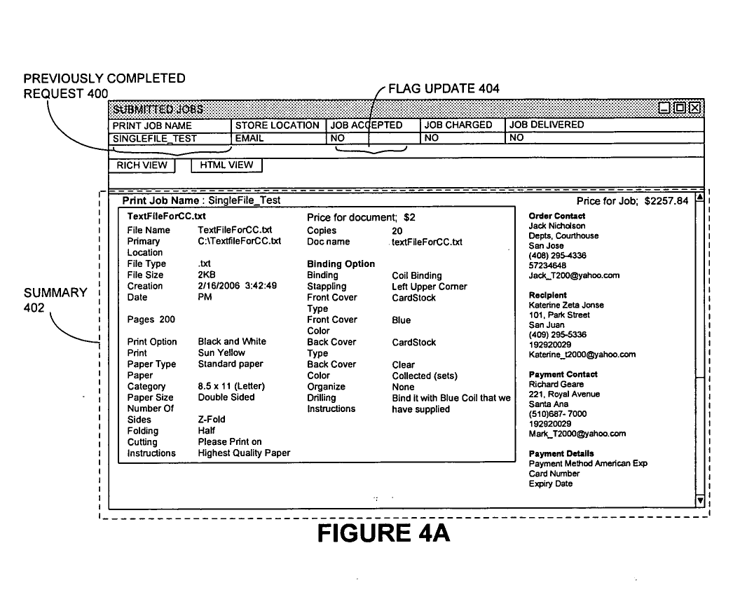

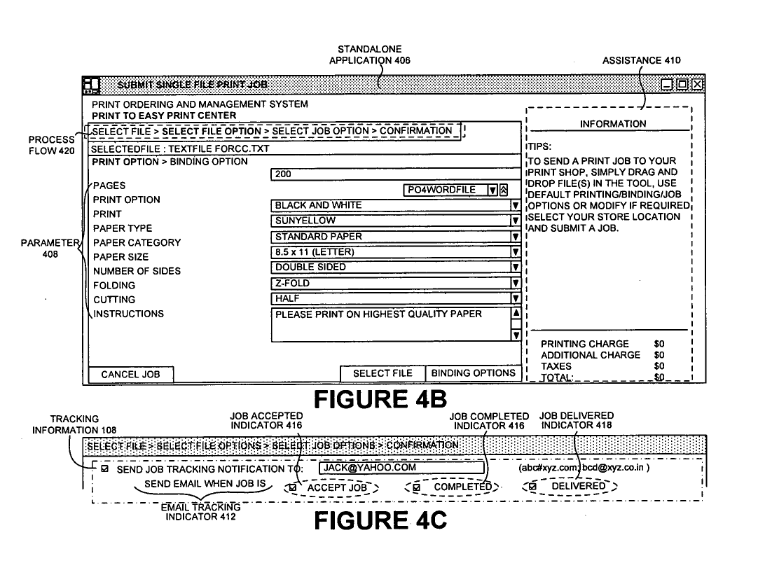

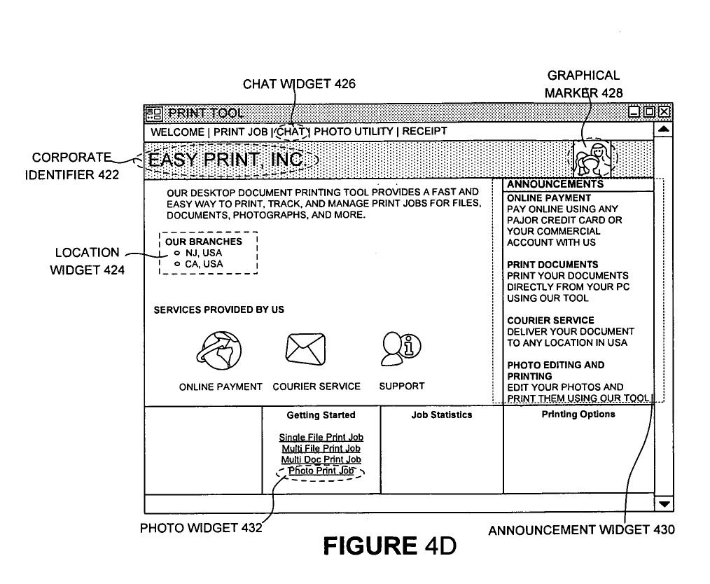

A reprographic submission and tracking system, apparatus, and method are disclosed. In the following description, for the purposes of explanation, numerous specific details are set forth in order to provide a thorough understanding of the various embodiments. It will be evident, however to the one skilled in the art that the various embodiments may be practiced without these specific details. An example embodiment provides methods and systems of a reprographic client module 100 (as illustrated in FIG. 1) to provide a summary 402 (e.g., the summary 402 of FIG. 4A) of at least one previously completed request 400 (e.g., the previously completed request 400 of FIG. 4A) associated with a reprographic submission (e.g., a print reproduction), generating a reproduction request 106 (e.g., a print request) customized based on a set of configurable parameters (e.g., print options, binding options, folding options, cutting options, paper size, etc.) and provide a tracking information 108 (e.g., the tracking information 108 of FIG. 1) of the reproduction request through a communication with a reprographic provider module 104 (as illustrated in FIG. 1) through a network 102 (e.g., the network 102 of FIG. 1).

Another example embodiment provides methods and systems of a reprographic provider module 104 (e.g., the reprographic provider module 104 of FIG. 1) to generate an update data (e.g., to update the reprographic client module 100) associated with a set of conditions (e.g., requirements) and constraints (e.g., restrictions) of a print shop when a parameter 408 (e.g., the parameter 408 of FIG. 4B) changes from a threshold value (e.g., a preset value) and propagate (e.g., disseminate) the update data to a plurality of reprographic client modules through a handshake notification system that automatically communicates the update data through a network 102 when the update data is refreshed.

An additional example embodiment provides methods and systems of a print shop having a reprographic provider module 104 to generate a messaging data and a tracking data (e.g., the tracking information 108 of FIG. 1) responsive to a reproduction request 106 (e.g., the reproduction request 106 of FIG. 1) of a reprographic client module 100 through a network 102, and to automatically propagate capacity and/or availability of printing equipment constraint data to the reprographic client module 100 and other reprographic client modules through the network 102 and a set of repeat clients each having a reprographic client module 100 to automatically apply a parameter 408 of a previously completed request 400 associated with a reprographic submission to the reproduction request 106.

It will be appreciated that the various embodiments discussed herein may/may not be the same embodiment, and may be grouped into various other embodiments not explicitly disclosed herein.

FIG. 1 is a network diagram of a reprographic client module 100 and a reprographic provider module 104 communicating a reproduction request 106 and/or a tracking information 108, through a network 102 (e.g., an internet network, a wide area network, a local area network, etc.) according to one embodiment. In one embodiment, a print shop (e.g., FedEx® Kinkos®, Alphagraphics®, a local print shop, etc.) having the reprographic provider module 104 generates a messaging data (e.g., an email, a confirmation message, etc.) and a tracking data (e.g., to keep track of the reproduction request 106) responsive to the reproduction request 106 of the reprographic client module 100 through the network 102, and automatically propagates capacity (e.g., printing capacity, delivery time, etc.) and availability of printing equipment constraint data (e.g., quantity of available printing media, packing media, etc.) to the reprographic client module 100 and other reprographic client modules (e.g., similar to the reprographic client module 100) through the network 102.

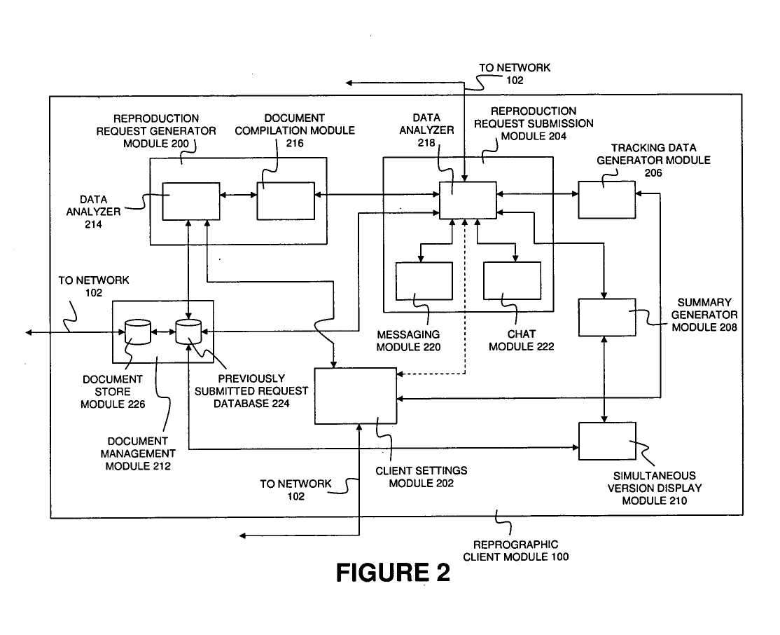

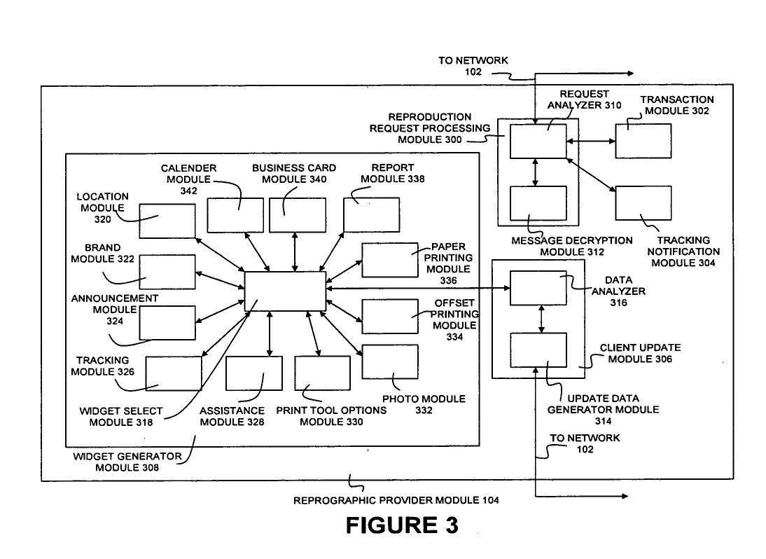

In another embodiment, a set of repeat clients (e.g., individuals, law firms, clients with frequent printing requirements, etc.) each having the reprographic client module 100 automatically applies a parameter 408 (e.g., printing options, paper size, delivery time, binding type, paper color, etc.) of a previously completed request 400 (e.g., a document and/or a project previously printed) associated with a reprographic submission to the reproduction request 106. Additional details of FIG. 1 are best understood with reference to FIG. 2 and FIG. 3 as will later be described.

FIG. 2 is an exploded view of the reprographic client module 100 of FIG. 1 having a reproduction request generator module 200, a client settings module 202, a reproduction request submission module 204, a tracking data generator module 206, a summary generator module 208, a simultaneous version display module 210 and/or a document management module 212, according to one embodiment. The reproduction request generator module 200 may generate the reproduction request 106 (e.g., a print request) based on a user selection (e.g., based on user printing preferences).

The reproduction request generator module 200 may include a data analyzer 214 and/or a document compilation module 216 according to one embodiment. In one embodiment the reprographic client module 100 (e.g., the reprographic client module 100 of FIG. 1) automatically applies the parameter 408 (e.g., the parameter 408 of FIG. 4B) of the previously completed request 400 (e.g., the previously completed request 400 of FIG. 4A) associated with the reprographic submission to the reproduction request 106 (e.g., the reproduction request 106 of FIG. 1). Particularly the data analyzer 214 may reference a previously completed request database 224 (e.g., a database and/or record of documents previously submitted for printing) and extract the parameter 408 (e.g., printing options, paper size, delivery time, binding type, paper color, etc.) from a particular previously completed request (e.g., based on user selection). The data analyzer 214 may then compare the extracted parameter (e.g., the parameter 408) to parameters of the client settings module 202 to determine applicability of the parameter 408 to the reproduction request 106 (e.g., to check availability of the parameter 408 at the time of application). The data analyzer 214 may then apply (e.g., incorporate) the parameter 408 to the reproduction request 106 (e.g., a new print request).

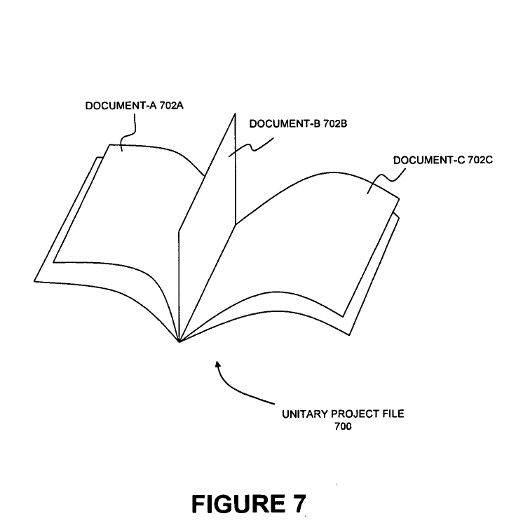

The document compilation module 216 may assist in compilation of documents with varied parameter settings to generate a single print job. In one embodiment the reprographic client module 100 may generate the reproduction request 106 (e.g., the reproduction request 106 of FIG. 1) by merging a set of documents (e.g., the set of documents as illustrated in FIG. 7) to a unitary project file (e.g., the unitary project file 700 of FIG. 7) comprising each of the set of documents. For example, a client (e.g., an individual, a law firm, a training institute, etc.) may be able to compile various documents (e.g., an index document, a content document, an appendix document, etc.) into a single project (e.g., a training manual, a thesis, etc.) instead of printing each document separately.

The reproduction request submission module 204 may assist in submitting and/or communicating the reproduction request 106 (e.g., the reproduction request 106 of FIG. 1) generated by the reproduction request generator module 200 to the reprographic provider module 104 (e.g., the reprographic provider module 104 of FIG. 1) through the network 102 (e.g., the network 102 of FIG. 1). In one embodiment the reprographic client module 100 may permit a submission of multiple distinct project files (e.g., unique documents that may not be related to each other) simultaneously to the reprographic provider module 104 through the network 102. For example, the client (e.g., a individual, a law firm, a training institute, etc.) may be able to select (e.g., choose) multiple project files and send them for print simultaneously as part of a single print job as compared to a sequential selection and printing of documents as individual print jobs.

The reproduction request submission module 204 may include a data analyzer 218, a messaging module 220 and/or a chat module 222, according to one embodiment. In one embodiment, the reprographic client module 100 may communicate the reproduction request 106 in a structured data (e.g., as illustrated in summary 402 of FIG. 4A) decryptable (e.g., process able) by the reprographic provider module 104. The structured data (e.g., an email) may include a meta data having a tracking information (e.g., the tracking information 108 of FIG. 1), a customer information (e.g., a customer profile), an acceptance information and/or a confirmation information (e.g., a job acceptance confirmation) that can be responded to by the reprographic provider module 104 according to another embodiment.

Particularly the data analyzer 218 may receive the reproduction request 106 from the reproduction request generator module 200. The data analyzer 218 may then communicate with the messaging module 220 and/or the tracking data generator module 206 to structure the reproduction request 106 in a structured message (e.g., an email) and embed the tracking information 108 (e.g., the tracking information 108 as illustrated in FIG. 4C) generated by the tracking data generator module 206 into the structured message. The reprographic provider module 104 may be able to respond (e.g., provide feedback to the reprographic client module 100 for the particular reproduction request) to the tracking information 108 embedded in the structured message.

The tracking data generator module 206 may generate customizable job tracking information related to the reproduction request 106 including a job accepted indicator 414 (e.g., the job accepted indicator 414 of FIG. 4C), a job completed indicator 416 (e.g., the job completed indicator 416 of FIG. 4C) and/or a job delivered indicator 418 (e.g., the job delivered indicator 418 of FIG. 4C) according to one embodiment. In one embodiment the reprographic client module 100 provides the tracking information 108 (e.g., embedded in a structured mail and/or integrated with the reproduction request 106) of the reproduction request 106 through a communication with a reprographic provider module 104 through a network 102 (e.g., as illustrated in FIG. 1).

In one embodiment the reprographic client module 100 and the reprographic provider module 104 may communicate with each other through a messaging system tied to a particular project and/or a particular document of the reproduction request 106. Particularly the chat module 222 of the reproduction request submission module 204 may allow an interactive chat session between a client (e.g., an individual, a law firm, a training institute, etc. using the reprographic client module 100) and a print-job administrator (e.g., administrator of the reprographic provider module 104) to allow the client and/or the print-job administrator to communicate any changes associated to a particular reproduction request. The chat module may preserve a copy of the chat sessions in a chronological order and tie it to the relevant reproduction request (e.g., similar to the reproduction request 106 of FIG. 1).

The reprographic client module 100 may permit an offline user of the reprographic client module 100 to automatically port parameters (e.g., parameter 408 of FIG. 4B) provided through an older process flow (e.g., associated to an older version) when the updated process flow (e.g., a new version) is integrated upon the offline user arriving online, according to one embodiment. For example, a user may be offline (e.g., not connected to a network) while generating the reproduction request 106. During the period, allowable parameter (e.g., the parameter 408) may have changed (e.g., based on changes made by to the reprographic provider module 104 by a print shop). The user may then have a choice to change to new parameters when the user comes online.

Specifically the data analyzer 218 may communicate with the client settings module 202 (e.g., to analyze and/or compare parameters associated to a particular reproduction request with parameters that may have been updated in the client settings module 202) prior to sending out the reproduction request 106. The data analyzer 218 may store a copy of the submitted reproduction request on a previously completed request database 224.

The summary generator module 208 may generate a summary (e.g., the summary 402 of FIG. 4A) of the reproduction request 106 (e.g., the reproduction request 106 of FIG. 1). The summary generator module 208 may also provide summaries of multiple reproduction requests along with a summarized financial information associated to each of the multiple reproduction requests. The simultaneous version display module 210 may display a summary (e.g., the summary 402 of FIG. 4A) of an old version of the reproduction request and a new version of the reproduction request concurrently. In one embodiment the reprographic client module 100 may enable future versions of tshe summary 402 to simultaneously display the at least one previously completed request (e.g., the previously completed request 400 of FIG. 4A) and the reproduction request (e.g., the reproduction request 106 of FIG. 1) through a retention of the at least one previously completed request and the reproduction request on a storage space associated with the reprographic client module 100.

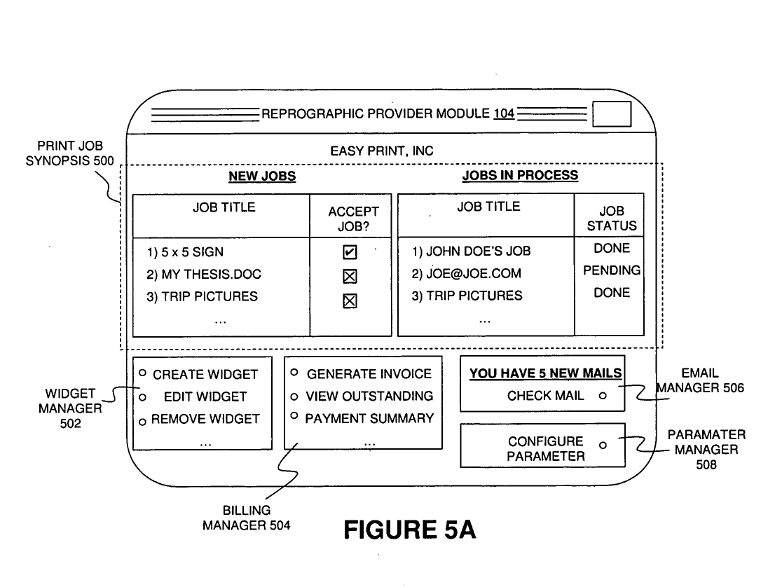

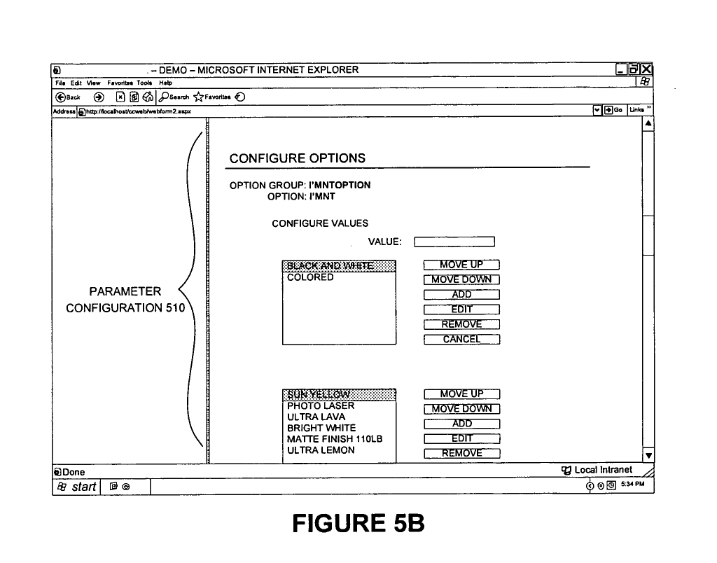

The client settings module 202 may control the availability of parameters (e.g., the parameter 408 of FIG. 4B) and/or the process flow associated to the generation of the reproduction request 106. In one embodiment, the reprographic client module 100 may periodically refresh a set of selectable parameters (e.g., the parameter 408 of FIG. 4B) of the reprographic client module 100 based on a data state change (e.g., based on a parameter configuration 510 of FIG. 5B) at a reprographic provider module 104 through the network 102. The data state change may be a new offering (e.g., a new kind of printing paper, a new printing option, etc.), a stock status of an item associated with the parameter (e.g., availability of a certain print media, etc.), an equipment availability (e.g., availability of a required equipment to process a print job), a scheduling capacity (e.g., available slots in a schedule) and/or a feature availability (e.g., availability of a certain print feature). The data state change may depend on changes and/or conditions related to a print shop (e.g., as conveyed by reprographic provider module 104).

The reprographic client module 100 may be automatically refreshed to an updated process flow (e.g., the process flow 420 of FIG. 4B) when a command (e.g., a client update command) of the reprographic provider module 104 provides revised interactivity data (e.g., updated settings) to the reprographic client module 100. The client settings module 202 may periodically communicate with the reprographic provider module 104 to receive the data state change and/or the updated process flow.

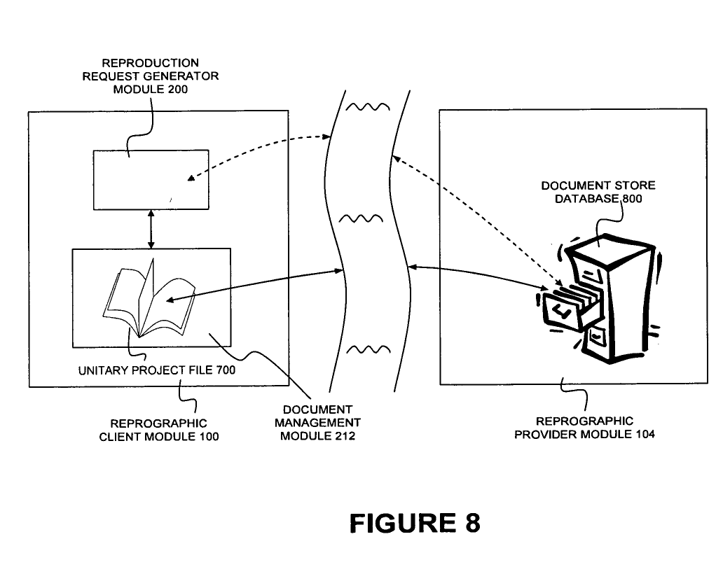

The document management module 212 may include the previously completed request database 224 and/or a document store module 226. The document management module 212 may be used to manage (e.g., select, organize, transfer and/or copy) documents that may be associated to a reproduction request (e.g., the reproduction request 106 of FIG. 1). The previously completed request database 224 may store the previously completed request (e.g., a previously generated, submitted and/or processed print request) of the reprographic client module 100. The document store module 226 may assist in managing (e.g., maintaining and/or administering) documents on a document store database 800 (e.g., the document store database 800 of FIG. 8). Additional details of the document management module 212 is best understood with reference to FIG. 8 as will later be described.

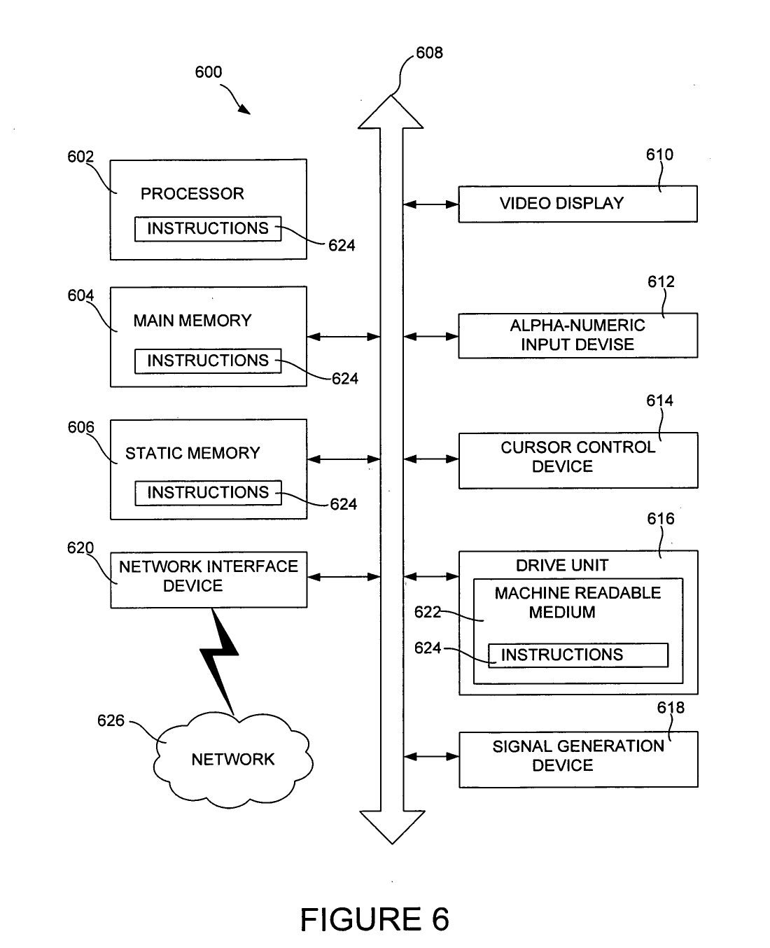

FIG. 3 is an exploded view of the reprographic provider module 104 of FIG. 1 having a reproduction request processing module 300, a transaction module 302, a tracking notification module 304, a client update module 306 and/or a widget generator module 308, according to one embodiment. The reproduction request processing module 300 may include a request analyzer 310 and/or a message decryption module 312, according to one embodiment. The reproduction request processing module 300 may process the reproduction request (e.g., the reproduction request 106 of FIG. 1) communicated by the reprographic client module 100 through the network 102. Particularly the request analyzer 310 may analyze and/or process (e.g., by using the processor 602 of FIG. 6) the reproduction request by referencing the message decryption module 312 to decrypt (e.g., decipher) the parameters (e.g., the parameter 408 of FIG. 4B) associated with the reproduction request to execute the reproduction request 106.

The transaction module 302 may process a transaction (e.g., a payment) associated to the reproduction request 106. The tracking notification module 304 may generate a notification based on processing of the tracking information (e.g., the tracking information 108 of FIG. 1) selected by a client (e.g., the job accepted indicator 414, the job completed indicator 416 and/or the job delivered indicator 418 of FIG. 4C) for the particular reproduction request. In one embodiment, the notification of a change in the customizable job tracking information (e.g., change in status of job accepted, job completed and/or job delivered) may be communicated through an automated voice message means, an email means, and/or a flag update (e.g., as illustrated by the flag update 404 of FIG. 4A) to the reprographic client module 100 through the network (e.g., the network 102 of FIG. 1).

The client update module 306 may include a data analyzer 316 and/or an update data generator module 314, according to on embodiment. In one embodiment the reprographic provider module 104 generates an update data (e.g., revised data) associated with a set of conditions and constraints (e.g., availability of print media, resources, schedule capacity, etc.) of a print shop when a parameter (e.g., the parameter 408 of FIG. 4B) changes from a threshold value (e.g., a preset value). Particularly the data analyzer 316 may periodically communicate with a widget select module 318 (e.g., to check for any change in widgets) and/or the update data generator module 314 (e.g., to check for parameter changes caused by the reprographic provider module as illustrated by parameter configuration 510 of FIG. 5B) to help generate the update data. The update data may be propagated to a plurality of reprographic client modules (e.g., similar to the reprographic client module 100 of FIG. 1) through a handshake notification system (e.g., a handshake protocol) that automatically communicates the update data through a network (e.g., the network 102 of FIG. 1) when the update data is refreshed (e.g., whenever a new update data is generated).

The widget generator module 308 may include a widget select module 318, a location module 320, a brand module 322, an announcement module 324, a tracking module 326, an assistance module 328, a print tool options module 330, a photo module 332, an offset printing module 334, a paper printing module 336, a report module 338, a business card module 340 and/or a calendar module 342, according to one embodiment. The widget generator module 308 may generate widgets to assist the reprographic client module 100 to generate the reproduction request 106 in a set of profile data associated with a printing category (e.g., a calendar category, a photo category, a business card category, a report category, an offset printing category, a paper printing category, etc.) associated with the reproduction request 106.

The widget select module 318 may provide a user interface for selecting widgets. The location module 320 may be used to generate a location widget (e.g., the location widget 424 of FIG. 4D) to allow a user and/or a client to search a print shop location on the reprographic client module 100. The brand module 322 may be used to generate a brand widget (e.g., as illustrated by the corporate identifier 422 and/or the graphical marker 428 of FIG. 4D) to allow a print shop to display its brand on the reprographic client module. In one embodiment, a corporate identifier (e.g., the corporate identifier 422 of FIG. 4D) of a reprographic provider module (e.g., the reprographic provider module 104 of FIG. 1) associated with the reprographic client module may be provided through a graphical marker (e.g., the graphical marker 428 of FIG. 4D) on an interface of the reprographic client module (e.g., the reprographic client module 100 of FIG. 1).

The announcement module 324 may be used to generate an announcement widget (e.g., the announcement widget 430 of FIG. 4D) to display advertisements and/or special offerings (e.g., discounts) on the reprographic client module. In one embodiment, the reprographic provider module 104 may provide a set of scrolling advertisement data to the plurality of reprographic client module to create incremental revenue opportunities to the reprographic provider module 104. The tracking module 326 may be used to generate a tracking widget (e.g., as illustrated by the tracking information 108 in FIG. 4C) to allow a user to keep track of a particular reproduction request (e.g., the reproduction request 106 of FIG. 1).

The assistance module 328 may be used to generate an assistance widget (e.g., the assistance widget 410 of FIG. 4B) to provide guidance and/or information to users in generating the reproduction request 106. The print tool options module 330 may be used to generate the print tool options widget to allow the reprographic provider module 104 choose (e.g., select) print options (e.g., print parameters) to be displayed on the reprographic client module. The photo module 332 may be used to generate the photo widget (e.g., the photo widget 432 of FIG. 4D) to allow a user to print and/or process photographic images. The offset printing module 334 may be used to generate the offset printing widget to allow a user to avail offset printing facilities.

The paper printing module 336 may be used to generate a paper printing widget to provide a user a breadth of paper printing options. The report module 338 may be used to generate a report widget to allow a user to print reports (e.g., special and/or customized reports). The business card module 340 may be used to generate a business card widget to facilitate printing of business cards through the reprographic client module. The calendar module 342 may be used to generate a calendar widget to permit a user to print calendars through the reprographic client module. Additional modules may be generated and/or added to provide widgets as per the requirements of the reprographic provider module 104.

FIG. 4A-4D are user interface views of the reprographic client module 100 of FIG. 1, having the previously completed request 400, the summary 402, a flag update 404, a standalone application 406, the parameter 408, an assistance widget 410, an email tracking indicator 412, the job accepted indicator 414, the job completed indicator 416, the job delivered indicator 418, the process flow 420, a corporate identifier 422, a location widget 424, a chat widget 426, a graphical marker 428, an announcement widget 430, and/or a photo widget 432 according to one embodiment. The previously completed request 400 may be data associated to previous reproduction request (e.g., collection of data related to print options, settings, print categories etc. associated to a particular document) previously generated, processed and/or submitted by the reprographic client module 100.

The summary 402 may be an information summary (e.g., print option information, binding option information, contact information, recipient information, payment information, etc.) associated to the previously completed request 400. The flag update 404 may be an interactive marker (e.g., based on a true or false response) to communicate and/or update tracking information associated with a particular reproduction request submitted to the reprographic provider module 104. For example, the flag update 404 may change from ‘NO’ to ‘YES’ if the submitted job was accepted by the reprographic provider module 104. The standalone application 406 may represent a type of access (e.g., an executable application on a client computer) to the reprographic client module 100. In one embodiment, the reprographic client module 100 may be accessed through a standalone driver, a print driver (e.g., the print driver would trigger the application) and/or a web based mark-up language application (e.g., a web based application).

The parameter 408 may be a paper size (e.g., A4, letter, etc), a delivery time, a binding type (e.g., coil binding, string binding, etc.) and/or a paper color, according to one embodiment. A client (e.g., an individual, a law firm, a training institute, etc.) may input values to the parameter 408 as per printing requirements. The assistance widget 410 may provide information (e.g., help and/or guidance) related to the process flow and/or the parameters associated in generating the reproduction request (e.g., the reproduction request 106 of FIG. 1). The email tracking indicator 412 may be an option that may be selected to receive tracking information (e.g., the tracking information 108 of FIG. 1) associated to a particular reproduction request through an email.

The job accepted indicator may be an available feature that may be selected to receive job acceptance acknowledgement (e.g., through email notification, flag update, voice mail, etc.) from the reprographic provider module 104 for a particular reproduction request. The job completed indicator 416 may be an available feature that may be selected to receive job completion intimation from the reprographic provider module 104. The job delivered indicator 418 may be an option that may be selected to receive information related to a job delivery from the reprographic provider module 104. The process flow 420 may indicate a progression of processes (e.g., user interface progressions) that need to be completed to generate a reproduction request (e.g., the reproduction request 106 of FIG. 1). The corporate identifier 422 may be a brand name and/or company identification of the reprographic provider module (e.g., the print shop) that may be displayed on the reprographic client module 100 (e.g., on the application interface). The location widget 424 may provide a user of the reprographic client module 100 with locations of print shops and/or allow the user to search a print shop based on user preference.

The chat widget 426 may allow a client (e.g., an individual, a law firm, a training institute, etc.) to interact with a print-job administrator at the print shop to communicate changes and/or special requirements associated with a particular reproduction request. The chat widget may store the chat data and tie it in a chronological order with the particular reproduction request. The graphical marker 428 may display a brand information (e.g., a logo) of the reprographic provider module 104 (e.g., the print shop) on the reprographic client interface. The announcement widget 430 may be used to display advertisements and/or special information (e.g., discounts, offers, etc.) provided by the reprographic provider module on the reprographic client module (e.g., on the user interface of the reprographic client module). In one embodiment the reprographic client module 100 may display a scrolling announcement bar having a set of advertisements periodically refreshed by the reprographic provider module 104. The photo widget 432 may be a photo printing category (e.g., facility to print and/or process photographs) offered by the reprographic provider module to the client.

FIG. 5A-5B are user interface views of the reprographic provider module 104 of FIG. 1 having a print job synopsis 500, a widget manager 502, a billing manager 504, a parameter manager 508 and/or a parameter configuration 510, according to one embodiment. The print job synopsis 500 may provide a summary of print jobs (new jobs, jobs pending, job queue, etc.) to a reprographic service provider (e.g., the print shop). The widget manager 502 may allow the reprographic provider to administer widgets (e.g., create new widgets, modify existing widgets, remove widgets, etc.) generated by a widget generator (e.g., the widget generator module 308 of FIG. 3). The billing manager 504 may permit the reprographic provider to supervise billing operations (e.g., generate invoices, view outstanding, etc.) and/or configure transaction options (e.g., related to the transaction module 302 of FIG. 3). The parameter manager 508 may allow the print shop to handle parameter settings. The parameter configuration 510 may be accessed through the parameter manager 508 and may allow the reprographic provider module 104 to change parameter settings (e.g., the parameter 408 of FIG. 4B) and create a data state change that may in turn refresh the set of selectable parameters of the reprographic client module 100.

FIG. 6 shows a diagrammatic representation of machine in the example form of a computer system 600 within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 600 includes a processor 602 (e.g., a central processing unit (CPU) a graphics processing unit (GPU) and/or both), a main memory 604 and a static memory 606, which communicate with each other via a bus 608. The computer system 600 may further include a video display unit 610 (e.g., a liquid crystal display (LCD) and/or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies and/or functions described herein. The software 624 may also reside, completely and/or at least partially, within the main memory 604 and/or within the processor 602 during execution thereof by the computer system 600, the main memory 604 and the processor 602 also constituting machine-readable media.

The software 624 may further be transmitted and/or received over a network 626 via the network interface device 620. While the machine-readable medium 622 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

FIG. 7 is a graphical illustration of the unitary project file 700 having a document-A 702A, a document-B 702B and/or a document-C 702C according to one embodiment. In one embodiment the reprographic client module 100 generates the reproduction request 106 by merging a set of documents (e.g., the document-A 702A, the document-B 702B and/or the document-C 702C) to the unitary project file 700 comprising each of the set of documents. The document-A 702A, the document-B 702B and/or the document-C 702C may have similar parameter and/or different parameters (e.g., the parameter 408 of FIG. 4B).

For example, a client (e.g., an individual, a law firm, a training institute, etc.) may wish to print a project (e.g., a training manual, a book, a thesis etc.). The project may comprise of several different documents (e.g., a front cover, a back cover, an index, a content list, etc.). The client may use the reprographic client module 100 to merge the different documents (e.g., the front cover, the back cover, the index, the content list, etc.) into the project (e.g., the training manual, the book, the thesis, etc.) and submit (e.g., for print) the project in its entirety to the print shop.

FIG. 8 is a graphical illustration of an interaction between the document management module 212 of FIG. 2 and a document store database 800, according to one embodiment. In one embodiment, the reprographic client module 100 (e.g., the reprographic client module 100 of FIG. 1) may access documents on a document store (e.g., the document store database 800) on the reprographic provider module 104 (e.g., the reprographic provider module 104 of FIG. 1) that can be reapplied (e.g., applied to a reproduction request) through a drag and drop methodology.

For example, a client can move and/or copy (e.g., through drag and drop using the document management module 212) a document (e.g., the document 702) from the client's machine to a document storage (e.g., the document store database 800) on a print shop machine (e.g., the reprographic provider module 104) through a network (e.g., the network 102). The document (e.g., the document 702) may be a frequently printed and/or used document (e.g., a previously completed request). The reproduction request generator module 200 (e.g., the reproduction request generator module 200 of FIG. 2) may use the document (e.g., the document 702) and/or parameters (e.g., the parameter 408 of FIG. 4B) associated to the document to generate the reproduction request 106 (e.g., the reproduction request 106 of FIG. 1). Furthermore, since the document (e.g., the document 702) may be stored on the reprographic provider module 104, the reprographic client module 100 may not have to send the document (e.g., the document 702) as a part of the reproduction request 106.

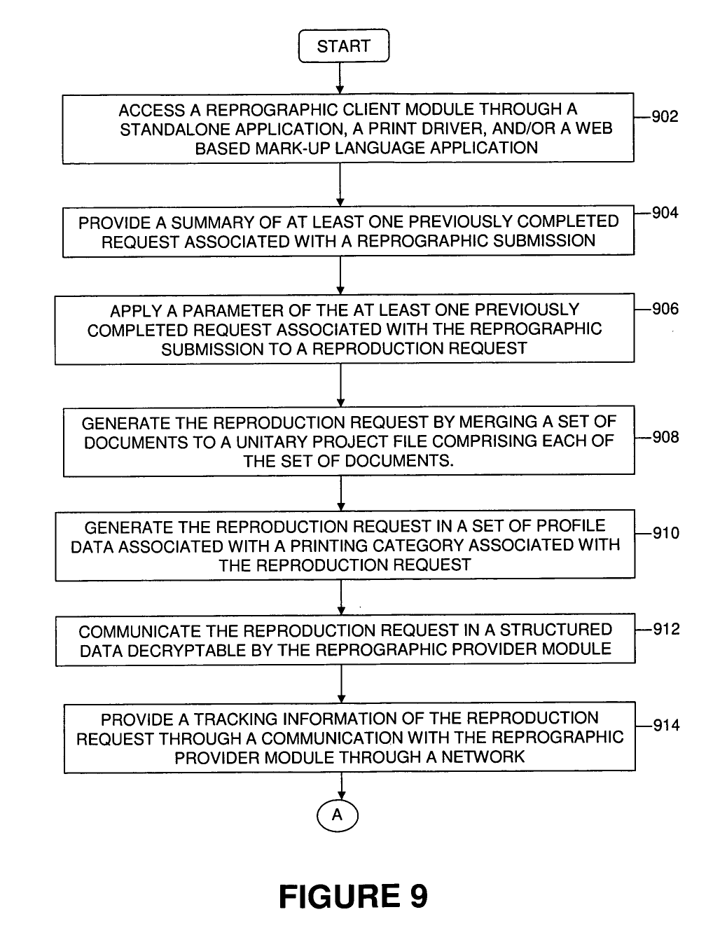

FIG. 9 is a flow chart illustrating a method of the reprographic client module 100 of FIG. 1 to generate the reproduction request 106, submit the reproduction request 106 to the reprographic provider module 104 and track the reproduction request 106 through the network 102, according to one embodiment. In operation 902, the reprographic client module (e.g., the reprographic client module 100 of FIG. 1) may be accessed through a standalone driver (e.g., a standalone application), a print driver (e.g., a printer driver installed on the client machine) and/or a web based mark-up language application (e.g., a web application). In operation 904, a summary (e.g., the summary 402 of FIG. 4A) of at least one previously completed request (e.g., the previously completed request 400 of FIG. 4A) associated with a reprographic submission may be provided (e.g., as illustrated by the summary generator module 208 of FIG. 2).

In operation 906, a parameter (e.g., the parameter 408 of FIG. 4B) of the previously completed request associated with the reprographic submission may be automatically applied (e.g., as illustrated in the reproduction request generator module 200 of FIG. 2) to the reproduction request (e.g., the reproduction request 106 of FIG. 1). In operation 908, the reproduction request may be generated by merging a set of documents (e.g., as illustrated in FIG. 7) to a unitary project file (e.g., the unitary project file 700 of FIG. 7) comprising each of the set of documents. The reproduction request may be customized (e.g., as per user preference) based on a set of configurable parameters (e.g., as configured by the reprographic provider module). In operation 910, the reproduction request may be generated in a set of profile data associated with a printing category (e.g., the photo widget 432 of FIG. 4D, etc.) associated with the reproduction request.

In operation 912, the reproduction request may be communicated in a structured (e.g., as illustrated by the summary 402 of FIG. 4A) data (e.g., using the messaging module 220 of FIG. 2) decryptable by the reprographic provider module. Further in operation 914, a tracking information (e.g., the tracking information 108 of FIG. 1) of the reproduction request may be provided through a communication with a reprographic provider module through a network (e.g., as illustrated in FIG. 1).

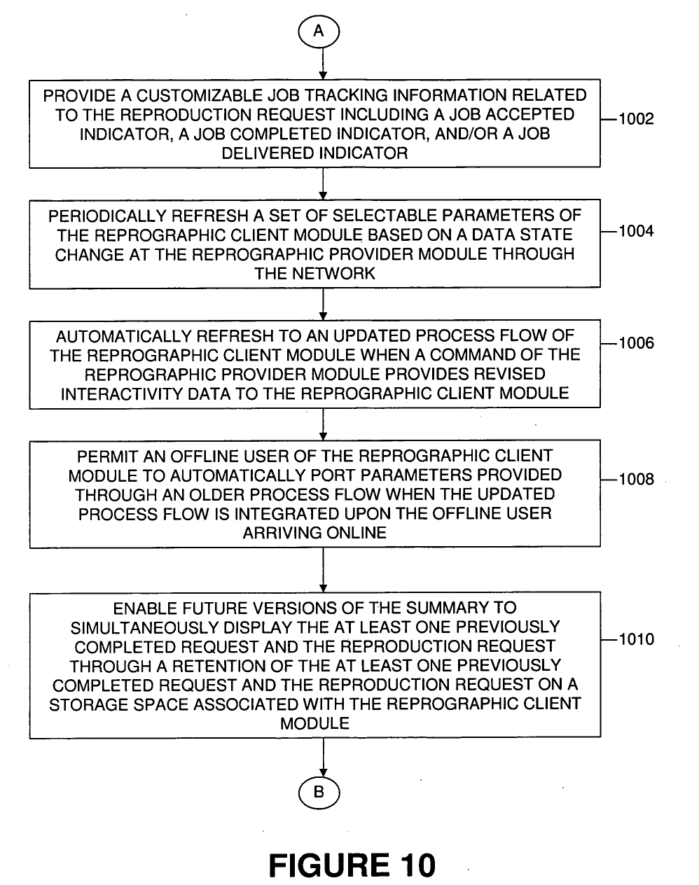

FIG. 10 is a process diagram that describes further the operations of FIG. 9, according to one embodiment. FIG. 10 begins with a ‘circle A’ that connotes a continuation from operation 914 of FIG. 9 (e.g., FIG. 9 concludes with the ‘circle A’). First in operation 1002, a customizable job tracking information related to the reproduction request (e.g., the reproduction request 106 of FIG. 1) may be provided (e.g., as illustrated by the tracking data generator module 206 of FIG. 2) including a job accepted indicator (e.g., the job accepted indicator 414 of FIG. 4C) a job completed indicator (e.g., the job completed indicator 416 of FIG. 4C), and/or a job delivered indicator (e.g., the job delivered indicator 418 of FIG. 4C).

In operation 1004, a set of selectable parameters (e.g., the parameter 408 of FIG. 4B) of the reprographic client module may be periodically refreshed (e.g., by updating the client settings module 202 of FIG. 2) based on a data state change (e.g., based on changes made by a print shop) at a reprographic provider module through a network (e.g., the network 102 of FIG. 1). In operation 1006, the reprographic client module may be automatically refreshed to an updated process flow (e.g., the process flow 420 of FIG. 4B) when a command of the reprographic provider module provides revised interactivity data to the reprographic client module (e.g., by updating the client settings module 202 of FIG. 2).

In operation 1008, an offline user (e.g., a user not connected to a network) of the reprographic client module may be permitted to automatically port parameters (e.g., the parameter 408 of FIG. 4B) provided through an older process flow when the updated process flow is integrated upon the offline user arriving online (e.g., as illustrated by the process of comparing parameter associated with a reproduction request with the parameter associated to the client settings module 202 of FIG. 2). In operation 1010, future versions (e.g., updated versions) of the summary (e.g., the summary 402 of FIG. 4A) may be enabled to simultaneously display the at least one previously completed request (e.g., the previously completed request 400 of FIG. 4A) and the reproduction request through a retention of the at least one previously completed request and the reproduction request on a storage space associated with the reprographic client module (e.g., as illustrated by the simultaneous version display module 210 of FIG. 2).

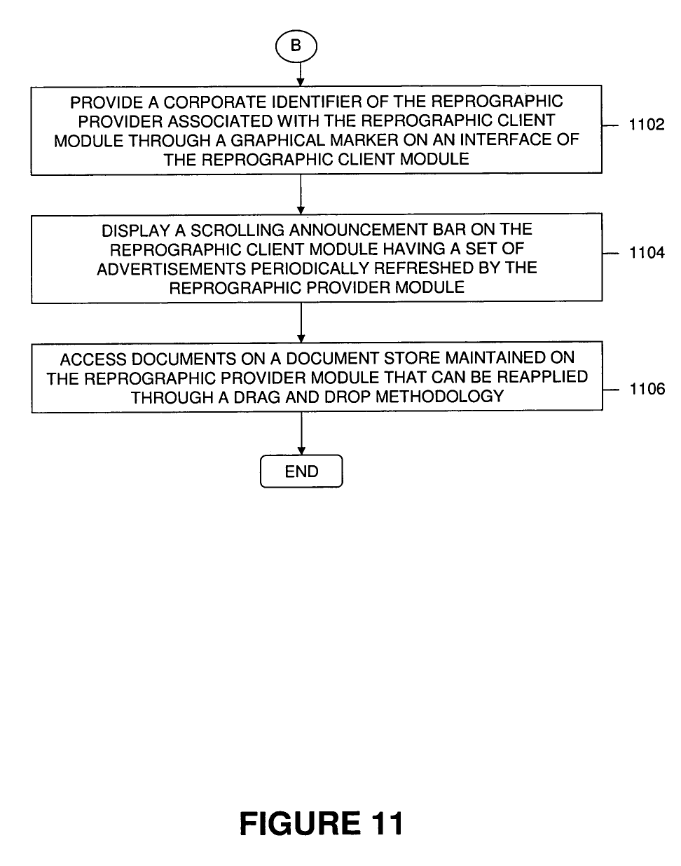

FIG. 11 is a process diagram that describes further the operations of FIG. 10, according to one embodiment. FIG. 11 begins with a ‘circle B’ that connotes a continuation from operation 1010 of FIG. 10 (e.g., FIG. 10 concludes with the ‘circle B’). In operation 1102, a corporate identifier (e.g., the corporate identifier 422 of FIG. 4D) of a reprographic provider associated with the reprographic client module may be provided through a graphical marker (e.g., the graphical marker 428 of FIG. 4D) on an interface of the reprographic client module.

In operation 1104, a scrolling announcement bar (e.g., the announcement widget 430 of FIG. 4D) may be displayed on the reprographic client module (e.g., the reprographic client module 100 of FIG. 1) having a set of advertisements periodically refreshed (e.g., periodically changed) by the reprographic provider module. In operation 1106, documents may be accessed on a document store (e.g., the document store database 800 of FIG. 8) maintained on the reprographic provider module that can be reapplied through a drag and drop methodology (e.g., as illustrated in FIG. 8).

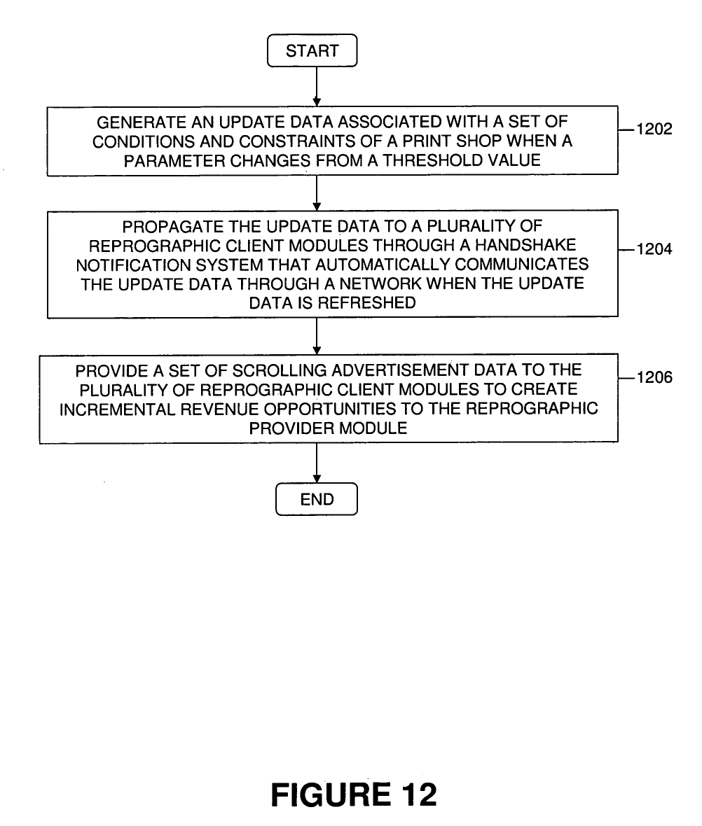

FIG. 12 is a flow chart illustrating a method of the reprographic provider module 104 of FIG. 1 to automatically update the reprographic client module 100 based on a set of conditions according to one embodiment. In operation 1202, an update data (e.g., parameters, process flow data etc.) associated with a set of conditions (e.g., availability) and constraints (e.g., limitations) of a print shop may be generated (e.g., as illustrated by the update data generator module 314 of FIG. 3) when a parameter (e.g., the parameter 408 of FIG. 4B) changes from a threshold value (e.g., a preset value).

In operation 1204, the update data may be propagated to a plurality of reprographic client modules (e.g., the reprographic client module 100 of FIG. 1) through a handshake notification system that automatically communicates the update data through a network (e.g., the network 102 of FIG. 1) when the update data is refreshed. In operation 1206, a set of scrolling advertisement data (e.g., as displayed in the announcement widget 430 of FIG. 4D) may be provided to the plurality of reprographic client modules to create incremental revenue opportunities (e.g., by leasing and/or monetizing advertisement space) to the reprographic provider module (e.g., the reprographic provider module 104 of FIG. 1).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the reprographic client module 100 (and all the modules in the reprographic client module 100 as illustrated in FIG. 2) and/or the reprographic provider module 104 (and all the modules within the reprographic provider module of FIG. 3), may be enabled using transistors, logic gates, and electrical circuits (e.g., application specific integrated ASIC circuitry) using a reproduction request generator circuit, a client settings circuit, a reproduction request submission circuit, a tracking data generator circuit, a summary generator circuit, a simultaneous version display circuit, a document management circuit, a reproduction request processing circuit, a transaction circuit, a tracking notification circuit, a client update circuit, and/or a widget generator circuit.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a reprographic client module, comprising:
providing a summary of at least one previously completed request associated with a reprographic submission;
generating a reproduction request that can be customized based on a set of configurable parameters; and
providing a tracking information of the reproduction request through a communication with a reprographic provider module through a network.

2. The method of claim 1 further comprising applying a parameter of the at least one previously completed request associated with the reprographic submission to the reproduction request.

3. The method of claim 2 further comprising periodically refreshing a set of selectable parameters of the reprographic client module based on a data state change at the reprographic provider module through the network.

4. The method of claim 3 further comprising communicating the reproduction request in a structured data decryptable by the reprographic provider module, wherein the structured data includes a meta data having at least one of tracking information, customer information, acceptance information, and confirmation information that can be responded to by the reprographic provider module.

5. The method of claim 3 further comprising displaying a scrolling announcement bar on the reprographic client module having a set of advertisements periodically refreshed by the reprographic provider module.

6. The method of claim 3 wherein the data state change is at least one of a new offering, a stock status of an item associated with the parameter, an equipment availability, a scheduling capacity, and a feature availability.

7. The method of claim 6 further comprising automatically refreshing to an updated process flow of the reprographic client module when a command of the reprographic provider module provides revised interactivity data to the reprographic client module.

8. The method of claim 7 further comprising permitting an offline user of the reprographic client module to automatically port parameters provided through an older process flow when the updated process flow is integrated upon the offline user arriving online, and wherein at least some historical data arranged in the older process flow, the updated process flow, and any other intermediate process flow is simultaneously comparable through a pivot field of the at least some historical data.

9. The method of claim 1 further comprising enabling future versions of the summary to simultaneously display the at least one previously completed request and the reproduction request through a retention of the at least one previously completed request and the reproduction request on a storage space associated with the reprographic client module.

10. The method of claim 9 further comprising generating the reproduction request by merging a set of documents to a unitary project file comprising each of the set of documents.

11. The method of claim 1 wherein the parameter is at least one of a paper size, a delivery time, a binding type, and a paper color.

12. The method of claim 1 further comprising accessing the reprographic client module through at least one of a standalone application, a print driver, and a web based mark-up language application.

13. The method of claim 1 further comprising providing a corporate identifier of a reprographic provider associated with the reprographic client module through a graphical marker on an interface of the reprographic client module, and wherein the reprographic provider to process the reproduction request through the network.

14. The method of claim 1 further comprising generating the reproduction request in a set of profile data associated with a printing category associated with the reproduction request, wherein the printing category is at least one of a calendar category, a photo category, a business card category, a report category, an offset printing category, and a paper printing category.

15. The method of claim 1 wherein the reprographic client module permits a submission of multiple distinct project files simultaneously to the reprographic provider module through the network in the reproduction request.

16. The method of claim 1 further comprising accessing documents on a document store maintained on the reprographic provider module that can be reapplied through a drag and drop methodology.

17. The method of claim 1 further comprising providing a customizable job tracking information related to the reproduction request including a job accepted indicator, a job completed indicator, and a job delivered indicator.

18. The method of claim 17 wherein a notification of a change in the customizable job tracking information is communicated through an automated voice message means, an email means, and a flag update to the reprographic client module through the network.

19. The method of claim 1 wherein the reprographic client module and the reprographic provider module communicate with each other through a messaging system tied to at least one of a particular project and a particular document of the reproduction request, and wherein the reprographic client module permits a draft status of the at least one of the particular project and the particular document prior to the communication with the reprographic provider module.

20. A method of a reprographic provider module, comprising:
generating an update data associated with a set of conditions and constraints of a print shop when a parameter changes from a threshold value; and
propogating the update data to a plurality of reprographic client modules through a handshake notification system that automatically communicates the update data through a network when the update data is refreshed.

21. The method of claim 20 further comprising providing a set of scrolling advertisement data to the plurality of reprographic client modules to create incremental revenue opportunities to the reprographic provider module.

22. The method of claim 20 in a form of a machine-readable medium embodying a set of instructions that, when executed by a machine, causes the machine to perform the method of claim 19.

23. A system comprising:
a print shop having a reprographic provider module to generate a messaging data and a tracking data responsive to a reproduction request of a reprographic client module through a network, and to automatically propagate capacity and availability of printing equipment constraint data to the reprographic client module and other reprographic client modules through the network; and
a set of repeat clients each having a reprographic client modules to automatically apply a parameter of a previously completed request associated with a reprographic submission to the reproduction request.

24. The system of claim 23 wherein the reprographic client modules are at least one of a printer driver and a standalone application distributed by a technology company.
